(19) United States
(12) Patent Application Publication
(10) Pub. No.: US 2016/0288723 A1
(43) Pub. Date: Oct. 6, 2016

(54) DETACHABLE TOTE BAG SYSTEM FOR A MOTOR VEHICLE

(71) Applicant: FORD GLOBAL TECHNOLOGIES, LLC, Dearborn, MI (US)

(72) Inventors: David Woodhouse, Troy, MI (US); Bonghoon Lukas Chung, Farmington Hills, MI (US)

(21) Appl. No.: 14/813,470

(22) Filed: Jul. 30, 2015

Related U.S. Application Data
(60) Provisional application No. 62/140,824, filed on Mar. 31, 2015.

(51) Int. Cl. B60R 7/04

(52) U.S. Cl. CPC B60R 7/043; B60R 2011/0012

(57) ABSTRACT

A detachable tote bag system is provided for a motor vehicle. That tote bag system includes a vehicle seat, a tote bag receiver on the vehicle seat and a detachable tote bag releasably held by the receiver.

This application claims the benefit of U.S. Provisional Patent Application Ser. No. 62/140,824 filed on 31 Mar. 2015, the full disclosure of which is incorporated herein by reference.

### TECHNICAL FIELD

This document relates generally to the motor vehicle field and, more specifically, to a detachable tote bag system for a motor vehicle.

### BACKGROUND

Motor vehicle users are always looking for convenient places to store and hold items in a motor vehicle. In many cases the typical storage options designed in the motor vehicles including, for example, glove boxes, console bins, console cupholders, instrument panel storage compartments, center stack storage compartments, door map pockets, seatback pockets and the like either do not provide enough dedicated storage or are simply not versatile enough to provide the best possible option. Further, these dedicated storage options are typically fixed and non-configurable to best meet the needs of the user. As a result, it is clear that a need exists for additional storage options in the interior trim of a motor vehicle.

This document relates to a detachable tote bag that may be releasably secured to the rear of a front seat of the motor vehicle to hold personal items in an aesthetically pleasing bag that is configured and color coordinated to match the vehicle. The bag may also be converted into a tray table while held on the rear of the front seat where it is positioned for convenient use by a rear seat occupant. In addition, the bag may be easily removed so that the user may take the bag and the items stored therein anywhere the user wishes to go outside the vehicle.

### SUMMARY

In accordance with the purposes of benefits described herein, a detachable tote bag system is provided for a motor vehicle. That detachable tote bag system comprises a vehicle seat, a tote bag receiver on the vehicle seat and a detachable tote bag releasably held by the receiver. The tote bag includes an internal storage compartment and a flap for opening and closing the storage compartment. In one configuration, the flap may be opened to form a tray table when the tote bag is secured to the vehicle seat.

In one possible embodiment, the receiver includes a first magnetic fastener. Further, the tote bag includes a second magnetic fastener that is attracted to the first magnetic fastener.

In another possible embodiment, the receiver includes at least one mounting post. Further, in this embodiment, the tote bag includes at least one mounting socket that is received over the mounting post when the tote bag is held by the receiver.

In another possible embodiment, the receiver includes a shelf and the mounting post projecting from the shelf. Further, in this embodiment, the tote bag includes a support base and the mounting socket is formed in the support base. When mounted on the vehicle seat, the support base rests on the shelf.

In another possible embodiment, the receiver includes the first magnetic fastener, at least one mounting post and the shelf while the tote bag includes the second magnetic fastener, the support base and at least one mounting post.

In accordance with a further aspect, a method is provided of storing a detachable tote bag on a vehicle seat. That method may be broadly described as comprising the steps of equipping the vehicle seat with a tote bag receiver and releasably securing the tote bag to the tote bag receiver.

The method may further include the step of providing the vehicle seat with a first magnetic fastener and the tote bag with a second magnetic fastener wherein the first magnetic fastener is attracted to the second magnetic fastener. Still further the method may include providing the receiver with at least one mounting post and providing the tote bag with at least one mounting socket wherein the at least one mounting post is received in the at least one mounting socket when the tote bag is held by the receiver.

In accordance with yet another aspect, a motor vehicle is provided including the detachable tote bag system described herein.

In the following description, there are shown and described several possible embodiments of the detachable tote bag. As it should be realized, the detachable tote bag is capable of other, different embodiments and certain details are capable of modification in various, obvious aspects all without departing from the tote bag as set forth and described in the following claims. Accordingly, the drawings and description should be regarded as illustrative in nature and not as restrictive.

### BRIEF DESCRIPTION OF THE DRAWING FIGURES

The accompanying drawing figures incorporated herein and forming a part of the specification, illustrate several aspects of the detachable tote bag system and together with the description serve to explain certain principles thereof.

FIG. 1 is a perspective view of the rear of a motor vehicle seat incorporating a detachable tote bag receiver.

FIG. 2 is a detailed perspective view of a detachable tote bag.

FIG. 3 is an exploded perspective view illustrating how the detachable tote bag is aligned with and secured to the receiver on the rear of vehicle seat.

FIG. 4 is a perspective view illustrating the detachable tote bag held on the receiver at the rear of the vehicle seat.

FIG. 5 is a perspective illustration showing how the flap on the tote bag may be opened to form a tray table while the tote bag is held in the receiver on the rear of the vehicle seat.

Reference will now be made in detail to the present preferred embodiments of the detachable tote bag system, examples of which are illustrated in the accompanying drawing figures.

### DETAILED DESCRIPTION

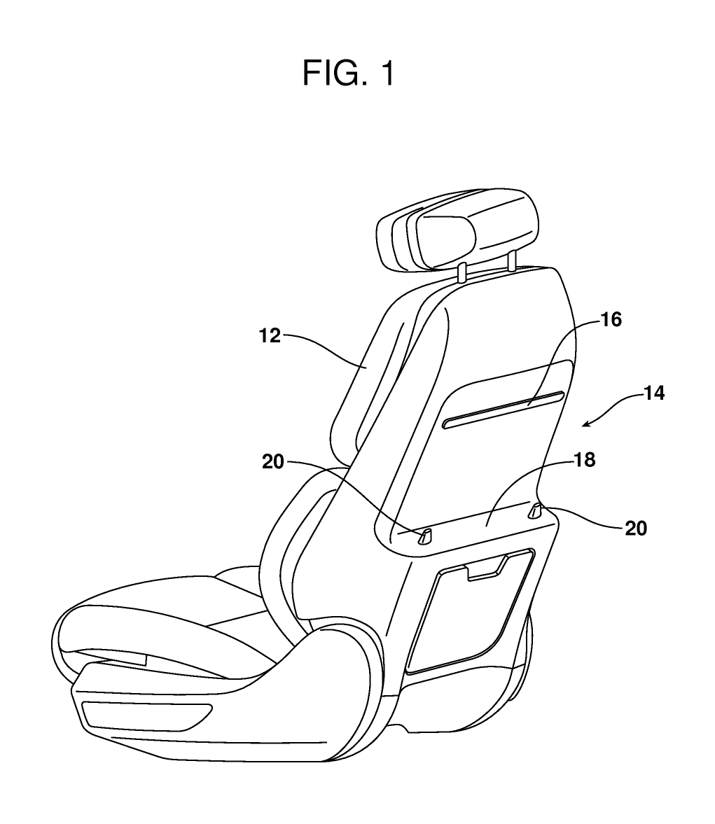

Reference is now made to drawing FIGS. 1-5 illustrating the detachable tote bag system 10. As illustrated in FIG. 1, the detachable tote bag system 10 includes a vehicle seat 12. A tote bag receiver 14 is provided on the rear of the vehicle seat 12.

In the illustrated embodiment, the tote bag receiver 14 comprises a first magnetic fastener 16 in the form of a magnetic or paramagnetic strip, a shelf 18 and two mounting posts 20 projecting upwardly from the shelf.

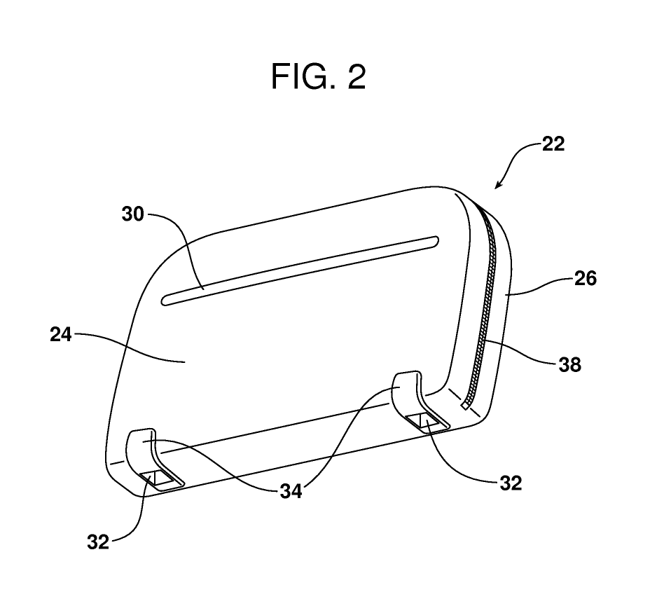

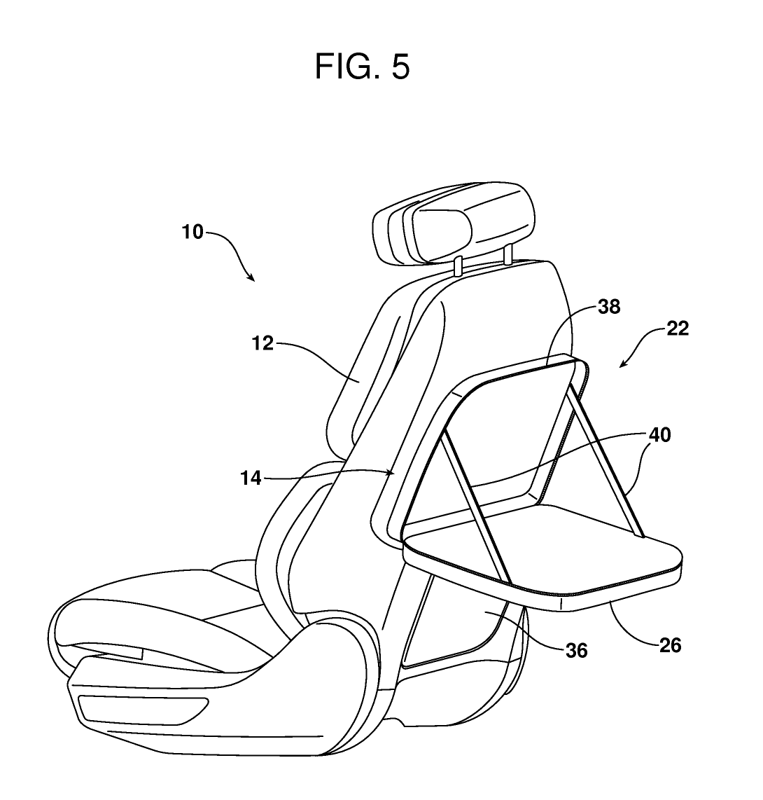

Reference is now made to FIG. 2 illustrating a detachable tote bag 22 which includes a body 24, such as a hard plastic shell covered by a leather skin. A zipper flap 26 may be opened to access the internal storage compartment 28 in the body (See also FIG. 5). The tote bag 22 also includes a second magnetic fastener 30 which may take the form of the magnetic or paramagnetic strip and two mounting sockets 32 formed in the two-piece support base 34.

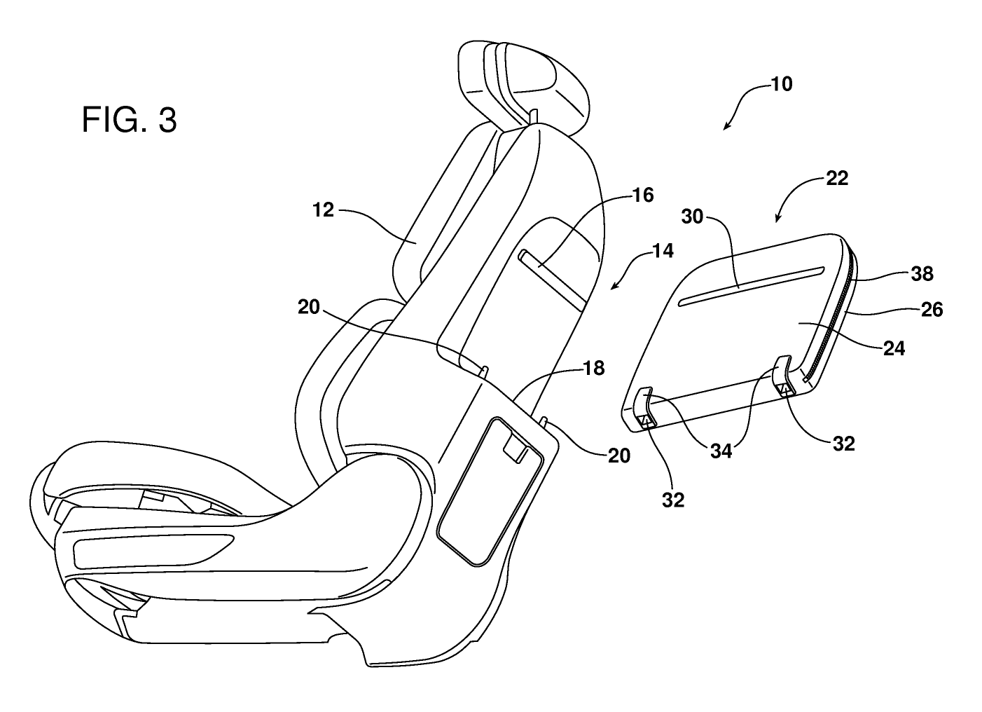

Reference is now made to FIG. 3, illustrating how the detachable tote bag 22 is secured to the tote bag receiver 14 on the rear of the vehicle seat 12. As illustrated, the tote bag 22 is oriented with the second magnetic fastener 30 toward the first magnetic fastener 16 of the receiver 14. The tote bag 22 is positioned so that the support base 34 rests on the shelf 18 with the mounting sockets 32 aligned with and received over the mounting posts 20. This effectively aligns the second magnetic fastener 30 on the tote bag 22 with the first magnetic fastener 16 on the rear of the vehicle seat 12. These two magnetic fasteners 16, 30 are attracted toward each other to secure the top of the tote bag 22 in position against the vehicle seat 12 where it is securely supported by the shelf 18.

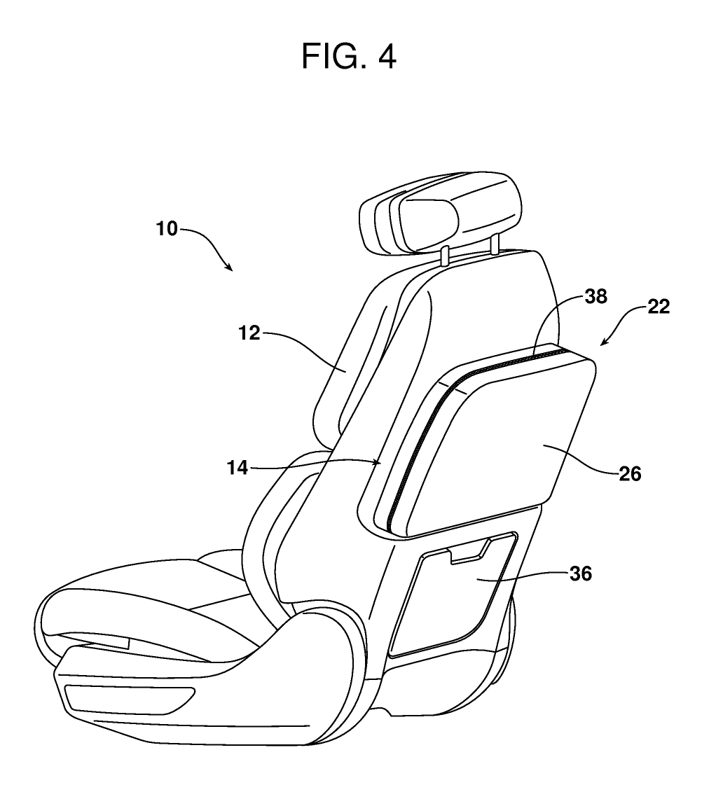

FIG. 4 illustrates the detachable tote bag 22 securely held by the receiver 14 on the rear of the vehicle seat 12. As should be appreciated, the vehicle seat 12 may also include an additional storage pocket 36 under the shelf 18, if desired.

Reference is now made to FIG. 5 illustrating how the zipper 38 on the tote bag 22 may be opened and the flap 26 folded down so as to form a tray table for use by an occupant of the rear seat (not shown) when the tote bag 22 is held in the receiver 14 on the rear of the vehicle seat 12. Two cooperative straps 40 are provided to hold the open flap 26 at the proper angular orientation to form the tray table. In an alternative embodiment, a locking hinge or other mechanical stop may be provided to hold the flap 26 at the desired angle to form the tray table.

When a user wishes to remove the tote bag 22 from the receiver 14 in order to take the tote bag and the contents contained therein with him outside of the motor vehicle, the user simply pulls the upper part of the tote bag 22 away from the vehicle seat 12 disengaging the two magnetic fasteners 16, 30 and then lifts the tote bag off the shelf 18, thereby freeing the mounting sockets 32 from the mounting posts 20.

In summary, the detachable tote bag system 10 provides a number of benefits and advantages. It allows one to conveniently carry items in a tote bag 22 that may be securely stored in the motor vehicle on the rear of a vehicle seat 12 in an aesthetically pleasing manner. Those items remain readily available in a convenient to reach position. Further, the tote bag 22 may be converted into a tray table that is easily accessed and used from second row vehicle seating when the tote bag is secured to the rear of the front row seat 12.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A detachable tote bag system for a motor vehicle, comprising:
a vehicle seat;
a tote bag receiver on said vehicle seat; and
a detachable tote bag releasably held by said receiver.

2. The tote bag system of claim 1, wherein said tote bag includes a storage compartment.

3. The tote bag system of claim 2, wherein said tote bag includes a flap for opening and closing said storage compartment.

4. The tote bag system of claim 2, wherein said receiver includes a first magnetic fastener.

5. The tote bag system of claim 4, wherein said tote bag includes a second magnetic fastener.

6. The tote bag system of claim 5, wherein said receiver includes at least one mounting post.

7. The tote bag system of claim 6, wherein said tote bag includes at least one mounting socket that is received over said at least one mounting post when said tote bag is held by said receiver.

8. The tote bag system of claim 7, wherein said receiver includes a shelf and said at least one mounting post projects from said shelf.

9. The tote bag system of claim 8, wherein said tote bag includes a support base and said at least one mounting socket is formed in said support base.

10. The tote bag system of claim 9, wherein said support base rests on said shelf when said tote bag is held by said receiver.

11. The tote bag system of claim 2, wherein said receiver includes at least one mounting post.

12. The tote bag system of claim 11, wherein said tote bag includes at least one mounting socket that is received over said at least one mounting post when said tote bag is held by said receiver.

13. The tote bag system of claim 12, wherein said receiver includes a shelf and said at least one mounting posts projects from said shelf.

14. The tote bag system of claim 13, wherein said tote bag includes a support base and said at least one mounting socket is formed in said support base.

15. The tote bag system of claim 14, wherein said support base rests on said shelf when said tote bag is held by said receiver.

16. The tote bag system of claim 2, wherein said receiver includes a shelf and said tote bag includes a support base, said support base resting on said shelf when said tote bag is held by said receiver.

17. A method of storing a detachable tote bag on a vehicle seat, comprising:
equipping the vehicle seat with a tote bag receiver;
releasably securing said tote bag to the tote bag receiver.

18. The method of claim 17 including providing the vehicle seat with a first magnetic fastener and the tote bag with a second magnetic fastener wherein said first magnetic fastener is attracted to said second magnetic fastener.

19. The method of claim 18 including providing said receiver with at least one mounting post and providing said tote bag with at least one mounting socket wherein said at least one mounting post is received in said at least one mounting socket when said tote bag is held by said receiver.

20. A motor vehicle including the detachable tote bag system of claim 1.
